(19) United States
(12) Patent Application Publication
(10) Pub. No.: US 2023/0115794 A1
(43) Pub. Date: Apr. 13, 2023

(54) METHOD FOR PRODUCING AEROGELS AND AEROGELS OBTAINED USING SAID METHOD

(71) Applicant: Fraunhofer-Gesellschaft zur Förderung der angewandten Forschung e.V., München (DE)

(72) Inventors: Damian HINTEMANN, Stadtlohn (DE); Nils MÖLDERS, Essen (DE); Manfred RENNER, Essen (DE); Andreas SENGESPEICK, Oberhausen (DE); Eckhard WEIDNER, Bochum (DE)

(21) Appl. No.: 17/913,738

(22) PCT Filed: May 11, 2021
(86) PCT No.: PCT/EP2021/062439

§ 371 Date: Sep. 22, 2022

(30) Foreign Application Priority Data
May 13, 2020 (DE) 10 2020 112 973.4

(51) Int. Cl. C01B 33/158; C01B 33/154; B01J 13/00; F16L 59/02

(52) U.S. Cl. CPC C01B 33/1585; C01B 33/154; B01J 13/0091; F16L 59/028

(57) ABSTRACT

The invention relates to a method for producing an aerogel using a sol-gel process, in which first a lyogel is formed from at least two precursor sols and the lyogel is then converted to an aerogel.

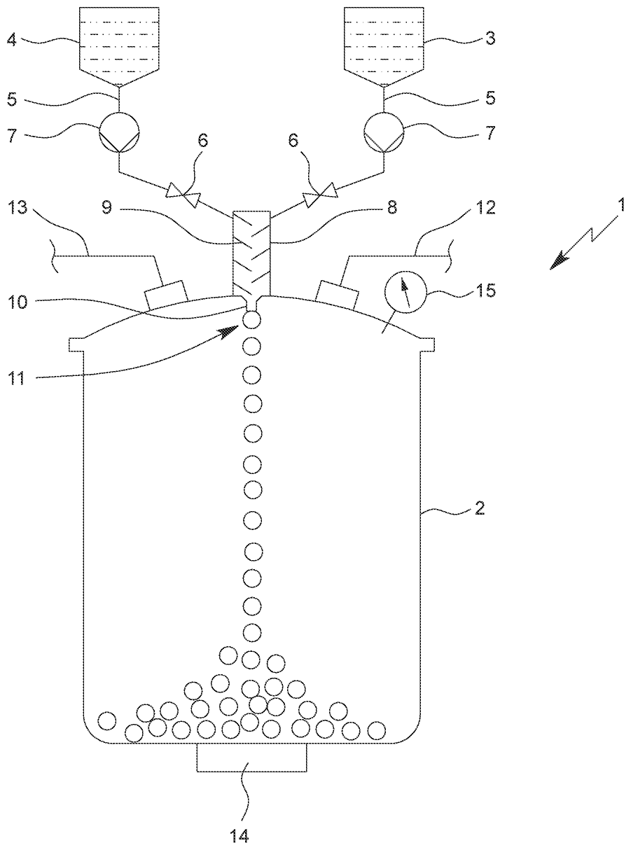

The present invention relates to the technical field of producing aerogels. In particular, the present invention relates to a method for producing an aerogel using a sol-gel process.

Furthermore, the present invention relates to aerogels, which in particular are obtainable by the method according to the invention, and to their use, in particular as or in insulation materials.

Furthermore, the present invention relates to an apparatus for producing aerogels.

Finally, the present invention relates to a method for producing a lyogel using a sol-gel process.

Aerogels are highly porous solids, the volume of which can consist of up to 99.98% pores. Aerogels usually comprise dendritic structures with a strong branching of the partial chains, so that very many interstices are formed, in particular in the form of open pores. The chains have a large number of contact points, so that a stable, sponge-like structure is formed. The pore size is usually in the nanometer range and the internal surface area can be up to 1,000 m²/g or more. Aerogels can be composed of a variety of materials, such as silica, plastic or carbon, as well as natural organic polymers, such as alginates, or metal oxides.

Aerogels are often used as insulating materials, for example for thermal insulation purposes, or as filter materials due to their high porosity. Similarly, aerogels are also used as storage materials, for example for liquids or gases.

Aerogels are nanostructured, open-pored solids, which are usually produced by a sol-gel process.

Aerogels are usually produced by drying a gelatinous gel, mostly condensed silicic acid. Aerogels obtained with silicic acids and similar starting materials such as silica sols, silane hydrolysates or silicates comprise SiO₂ structural units and are often referred to as silica aerogels. The first synthesis of silica aerogels was achieved by Steven Kistler in 1931/1932, when he was the first to develop a method of drying gels without the gels showing any shrinkage (Kistler S. S., The Journal of Physical Chemistry 1932, 36(1): Coherent expanded Aerogels, pp. 52-64). In the method developed by Kistler, water glass is used as the starting material, from which a silica hydrogel is obtained in a first step by acidification with a mineral acid. In the next step, this gel is freed from alkali metal ions by washing. The water contained in the hydrogel is then completely exchanged for ethanol or methanol. This is followed by supercritical drying of the resulting alcogel in an autoclave.

In the meantime, further methods have been developed, such as that described in DE 18 11 353 A. DE 18 11 353 A discloses a method for producing silica aerogels, wherein tetraethoxysilane (TEOS) is hydrolyzed in methanol or ethanol with a precisely metered amount of water and a catalyst. During hydrolysis, an SiO₂ gel in the form of an alcogel is formed under cleavage of alcohol and water. The alcogel is then dried supercritically in an autoclave. This method can also be used to produce organic aerogels from melamine formaldehyde resins and resorcinol formaldehyde resins. In the supercritical drying techniques, the gel to be dried is subjected to temperature and pressure conditions at which at least the critical point of the solvent used is reached.

The disadvantages of such supercritical drying techniques, which are based on supercritical conditions of the solvent used, are the temperature and pressure conditions and a discontinuous mode of operation. For example, when drying water-containing gels, temperatures of at least 370° C. and pressures of at least 220 bar are required. When drying gels containing methanol, temperatures of at least 240° C. and pressures of at least 81 bar are required.

An alternative to this supercritical drying process is the use of compressed carbon dioxide. A method for drying with supercritical carbon dioxide is disclosed in EP 171 722 A, for example. In this process, the organic solvent is exchanged for liquid carbon dioxide prior to supercritical drying. Supercritical drying with CO₂ then takes place at much lower temperatures, for example at the critical temperature of 31.1° C. and the critical pressure of 73.9 bar of the carbon dioxide.

Industrially, aerogels are often produced using the Cabot method. This is described, for example, in DE 19 648 798 A and DE 69 903 913 T2. For this purpose, diluted sodium silicate is reacted with hydrochloric acid at 60 to 80° C., wherein the gelation time, i.e. the time required for gel formation, can be set to a few minutes. For solidification and maturation of the gel, the gel is then tempered at 80 to 100° C. The aging time is specified as 30 minutes. During the aging process or afterwards, the gel is washed until the wash water is free of electrolytes.

This is followed by silanization of the hydrogel to enable subcritical drying. Trimethylchlorosilane is used as the silanizing agent. Trimethylchlorosilane reacts largely with the water present in the hydrogel to form trimethylsilanol and condenses further to form hexamethyldisiloxane, which is incorporated into the pores and partially displaces the water.

It should be noted here that the silanizing agent used is added in very large quantities. For example, 100 g of hydrogel is reacted with 140 ml of trimethylchlorosilane. Only with this ratio of hydrogel to trimethylchlorosilane a partial reaction of the hydroxide groups on the silicon is achieved. As alternative silanizing agents, hexamethyldisiloxane and hydrochloric acid are used in the gas stream. Here, a partial reversal reaction of the hexamethyldisiloxane to the trimethylchlorosilane occurs, which can then react with the hydroxyl groups of the silicon.

Looking at the molar ratios of HCI and hexamethyldisiloxane in the examples of the patents and patent applications mentioned above, it can be seen that hexamethyldisiloxane is added in five to six times excess and that only a small part of the hexamethyldisiloxane used can react to form the trimethylchlorosilane. This shows the importance of incorporating the hexamethyldisiloxane in the pores of the lyogel. Only in this way can subcritical drying be carried out. The drying itself is then carried out in a 200° C. nitrogen stream.

In the Aerogel Handbook (M. A. Aergerter et al., Aerogels Handbook, Advances in Sol-Gel Derived Materials and Technologies, 2011, p. 120), the importance of the molar ratio of silanizing agents to SiO₂ network is discussed in more detail. The hydrophobization step using a large amount of trimethylchlorosilane, which is toxic, flammable, and corrosive, represents the costliest method step in producing aerogels by the Cabot process.

In drying processes, it is also often found that solvent exchange, in particular from polar solvents to less polar solvents, is important for successful drying.

From Kistler's studies on sodium silicate-based aerogels, it is known that solvent exchange from water to ethanol does not cause any significant change in pore geometry. This result is independent of whether the solvent exchange is carried out in one step or in several steps with increasing ethanol content. For the direct supercritical drying of SiO₂ gels from ethanol practiced there, a mass fraction of ethanol of 95 wt. % is sufficient. For supercritical drying using CO₂, on the other hand, no value is known.

The solvent exchange from water to ethanol under the influence of compressed CO₂ is investigated by Gurikov et al. The gels used consist of alginate and are produced using CO₂-induced gelation. The samples comprise a diameter of 10 to 12 mm and are positioned in a preheated autoclave and subjected to supercritical CO₂ (120 bar, 313 K). Mixtures of water and ethanol are then pumped into the autoclave in several stages, and solvent exchange is carried out for 2.5 hours per stage, wherein an ethanol content of 30 wt. % is achieved in the first stage, 60 wt. % in the second stage, and 90 wt. % in the third stage. The gels are then rinsed with 25 wt. % ethanol in CO₂ to completely extract the water from the pores before the gels are supercritically dried for 3 hours. The progress of the solvent exchange is analyzed using the composition calculated from the density of the solvent. For this purpose, 5 ml samples are taken from each autoclave. Under the given conditions, the time required for the respective solvent exchange steps was reduced from 12 hours to 2.5 hours.

The use of supercritical carbon dioxide during solvent exchange additionally reduces the required drying time from 6 hours to 3 hours.

The density of the gels after solvent exchange under the influence of compressed CO₂ is 0.021 g/cm3, the specific surface area according to BET is 538 m2/g and the pore volume according to BJG is 5.96 cm3/g. The obtained aerogels comprise similar properties as the reference samples prepared via solvent exchange at ambient conditions. A direct influence of solvent exchange under pressure on the properties of the prepared aerogels cannot be deduced from the available data, since different synthesis conditions are used for the different processes.

In addition to the previously described challenge of stabilizing the gel during the drying process, another problem in producing aerogels, in particular silica aerogels, is represented by the long process times. These make aerogel production more expensive and thus prevents the use of aerogels in a large number of applications for which aerogels would be suitable on the basis of their physical property profile. The respective process times for the individual method steps in the production of silica aerogels from tetraethyl orthosilicate (TEOS) are as follows:
Hydrolysis and condensation times at least 8 hours (cf. A. A. Tweij Wesam, Temperature Influence on the Gelation Process of Tetraethylorthosilicate using Sol-Gel Techique, Iraqi Journal of Science 2009).
Gel aging times range from 6 to 72 hours (see Einarsrud, M.-A., Kirkedelen, M. B., Nilsen, E., Mortensen, K., Samseth, J., Structural Development of Silicagels aged in TEOS, Journal of Non-Cryst Solids 231, 1998, pp. 10-16).
Supercritical washing times/solvent exchange approx. 24 hours per wash cycle (cf.

Kerstin Quarch, Product design on colloidal agglomerates and gels, gelation and fragmentation of inorganic silica, PhD thesis, KIT, 2010).
The supercritical drying times are strongly dependent on the preceding solvent exchange and the sample size

A significant improvement is achieved by the one-pot method developed by the Swiss Federal Laboratories for Materials and Testing (EMPA), whose individual steps require the following time:
The time for gel formation and aging is about 2 hours by using hexamethyldisilazane (HDMSO), ammonia, water, ethanol and TEOS.
Hydrophobing of the wet gel is performed using a mixture of HCl and HDMSO over a period of 1 hour.
The supercritical drying time is about 1 hour.

Thus, the total process times are between 4 and 6 hours.

However, even these process times still pose major challenges for large-scale industrial producing, wherein in particular hydrophobing also requires working with large surpluses of hydrophobing agents to obtain the necessary hydrophobing for solvent exchange.

Another problem common to all of the methods for producing aerogel mentioned above is that usually undefined particles without a regular external shape are obtained, which are difficult to use in loose filling or even for incorporation into insulating plaster systems. These irregular particles are mechanically much less resilient and form less dense sphere packings than would be expected for regular, in particular spherical particles. For this reason, the effectiveness of aerogels in practice often falls short of the calculated values.

Thus, the prior art still lacks a system to reproducibly produce aerogels with significantly reduced process times, enabling continuous or quasi-continuous production at reduced costs. Furthermore, it is equally not possible to produce aerogels with a defined geometric structure on an industrial scale and in a reproducible manner. For many applications, in particular ball-shaped, i.e. spherical, aerogel particles are preferred, as these are likely to comprise a significantly higher mechanical load-bearing capacity.

Similarly, it is not yet possible to produce aerogel particles with preselected particle sizes in a targeted manner.

It is now an object of the present invention to eliminate, or at least to mitigate, the disadvantages associated with the described prior art.

In particular, it is an object of the present invention to provide a method for producing aerogel particles which can be carried out with significantly shorter process times and preferably continuously or quasi-continuously.

A further object of the present invention is to be seen in being able to produce aerogels with defined properties, in particular also defined external shape and defined particle size, in a targeted manner.

In addition, a further object of the present invention is to provide an aerogel which is mechanically resilient and is suitable in particular for use in insulating materials.

The objective set out above is solved according to the present invention by a method according to claim 1; further, advantageous further developments and embodiments of the method according to the present invention are subject of the respective dependent claims.

Further subject-matter of the present invention according to a second aspect of the present invention is an aerogel according to claim 15. Further advantageous embodiments of this aspect of the invention are subject of the respective dependent claim.

Again, further subject-matter of the present invention according to a third aspect of the present invention is the use of an aerogel according to claim 17.

A further subject-matter of the present invention according to a fourth aspect of the present invention is the use of an aerogel according to claim 18.

Again, another subject-matter of the present invention—according to a fifth aspect of the present invention—is an apparatus for producing aerogels according to claim 19.

Finally, subject-matter of the present invention—according to a sixth aspect of the present invention—is a method for producing a lyogel according to claim 20.

It goes without saying that special features, characteristics, embodiments and advantages or the like which are set forth below only with respect to one aspect of the invention—for the purpose of avoiding unnecessary repetition —, naturally apply accordingly with respect to the other aspects of the invention without the need for express mention.

In addition, it applies that all values or parameters or the like mentioned in the following can in principle be determined with standardized or explicitly stated determination methods or determination methods familiar to the skilled person in this field.

Furthermore, it goes without saying that all weight- or quantity-related percentages are selected by the person skilled in the art in such a way that the total results in 100%; this is however self-evident.

With this proviso made, the present invention will now be described in more detail below.

Subject-matter of the present invention—according to a first aspect of the present invention—is a method for producing a silica aerogel using a sol-gel process, in which first a lyogel is formed and the lyogel is then converted into an aerogel, wherein for producing the lyogel at least two precursor sols, preferably two precursor sols, are mixed with each other, wherein a first precursor sol comprises an acidic pH value or a basic pH value and a second precursor sol comprises a pH value different from the first precursor sol.

For, as the applicant has surprisingly found out, on the basis of the method according to the invention, first an in particular homogeneous, uniformly structured as well as uniformly formed lyogel can be obtained in a particularly time-efficient manner, from which preferably spherical aerogel particles are then accessible.

It is a particular advantage of the present invention that the production of the lyogel, in particular the rate at which the lyogel is formed, can be precisely and specifically influenced on the basis of the precursor sols used in the production or formation of the lyogel, which in particular comprise specifically adjusted pH values. In this respect, it has proven well if the method according to the invention, in particular the producing of the lyogel, is carried out within specific pH value ranges, wherein these can be precisely adjusted as well as controlled by means of the procedure according to the invention. For example, by shifting the pH from the neutral to the weakly acidic or basic range, a relative slowing down of gel formation or gelation by a few seconds can be achieved, so that homogeneous and uniform mixing of the precursor sols is possible immediately before the onset of gel formation. In contrast, in particular instantaneous gelation occurs if the method according to the invention is carried out at neutral pH. The present invention thus makes use in particular of the pH dependence of the gelation or the gel formation rate in order to exert a specific influence on the lyogel formation on this basis, in particular with regard to shaping and gel particle sizes. For example, the method according to the present invention makes it possible to produce spherical lyogel particles whose diameter can be adjusted to several millimeters.

The present invention is characterized by a simple and straightforward procedure in which gel formation can be carried out in particular without pressure or at atmospheric pressure or at only slightly elevated pressures, preferably at pressures of not more than 40 bar. Up to now, it has not been possible to produce spherical silica aerogels or lyogels without pressure from preferably at least partially aqueous-based precursor sols, at least not in a method that can be carried out quickly and easily. Only known is a method in which a sol is dropped pressure-less into an oil so that spherical particles are configured, which then gel slowly (cf. Lee, Kyoung-Jin, Fast Synthesis of Spherical Silica Aerogel Powders by Emulsion Polymerization from Water Glass, ChemistrySelect, Vol 3. Issue 4, Jan. 31, 2018). However, in particular, the use of an oil as a solvent or surrounding medium is not necessary or intended in the context of the present invention.

Furthermore, a rapid gelation of the precursor sols can be achieved in the method according to the invention, in particular within a few seconds. In this way, short process times can be achieved with a low apparatus expenditure. In particular, within the scope of the present invention, the process time for producing silica aerogels from gel formation to drying completion—if all method steps are carried out in the same reaction apparatus—can be reduced to times of 1 to 2 hours, in particular less than 1.5 hours.

A major difficulty or challenge in the producing of aerogels is in particular to produce uniform, homogeneous and structurally homogeneous particles. This difficulty can be reliably overcome with the method according to the invention. In particular, the controlled metering or mixing of the different precursor sols makes it possible to time the gelation in such a way that uniform, homogeneous mixing or distribution of the precursor sols within each other is ensured. Likewise, within the scope of the present invention, it becomes possible to control gel formation and the introduction or incorporation of the precursor sol or the gel formed therefrom in such a way that a stable gel can be obtained, in particular in the form of spherical gel particles, wherein these particles can then be further converted to, in particular spherical, aerogel particles.

Here, the method according to the invention in particular also makes it possible to specifically influence or adjust the size of the lyogel particles or their particle size distribution. In particular, the gelation time or duration of gel formation and the way in which the precursor sols are mixed with each other and immediately thereafter supplied to the reaction apparatus according to the invention allow directed generation of lyogel particles of defined shape and size. The particles according to the invention do not lose this, in particular ball-like or spherical, shape and size even if the lyogel is converted into an aerogel.

The aerogel particles obtained by the method according to the invention, in particular spherical or cylindrical ones, are characterized over known prior art aerogels, which are predominantly non-uniformly shaped or cubic, by better flowability, higher strength under uniaxial compressive loading and more optimum packing density, which can be attributed in particular to the uniform spherical or ball-like shape. The aerogels according to the invention, in particular those with a spherical or ball-like shape, are not yet accessible by the methods for producing aerogels known from the prior art. The procedure or method according to the invention alone make it possible to reliably produce aerogel particles with an in particular spherical shape and a circular cross-section.

The spherical aerogel particles accessible by the method according to the invention are excellently suited as thermal insulation materials, in particular in loose filling, but also for incorporation into insulating plaster systems, due to their excellent mechanical properties or resistance as well as the possibility of producing dense spherical packings. Due to the in particular improved flowability, higher strength under uniaxial compressive load and higher packing density compared to conventional aerogel powders, which are usually based on shapeless or cubic particles, the spherical aerogels according to the invention can preferably be used in powder fills or powder mixtures such as thermal insulation plasters.

In the context of the present invention, a sol-gel process is understood to be a method in which non-metallic inorganic or organic materials or inorganic-organic hybrid materials are obtained from colloidal dispersions, the so-called sols. In a sol-gel process, particles in the nanometer range are usually obtained from a colloidal dispersion, the sol, by aggregation, which subsequently, by further condensation and aggregation, form a gel, i.e., a three-dimensional network whose pores are filled with a fluid, wherein the fluid is either a liquid or a gas.

In the context of the present invention, a gel is to be understood as a dimensionally stable disperse system rich in liquids and/or in gases and consisting of at least two components, which are at least a solid, colloidally divided substance with long or widely branched particles, such as gelatin, silicic acid, montmorillonite, bentonite, polysaccharides, pectins and others, and a fluid, in particular a gas or a liquid, as dispersant. In this case, the solid substance is coherent, i.e. it forms a spatial network in the dispersant, wherein the particles adhere to each other by secondary or principal valences at different points, the so-called adhesion points. If the spaces between the particles are filled with a liquid, a lyogel is present. If the dispersant is air, the gel is called an aerogel. For further details on the term gel, please refer to the entry on the keyword “gels” in ROEMPP Chemie Lexikon, 9th expanded and newly processed edition, belt 2, 1999, p. 1511.

A lyogel is a gel, i.e. a three-dimensional network whose pores are filled with a liquid. Special cases of the lyogel are the hydrogel, in which the liquid is water, or the alcogel, in which the liquid is an alcohol, usually ethanol. Lyogels which contain organic solvents are also referred to as organogels.

In the context of the present invention, a sol means a solution or a finely divided dispersion, i.e., a colloidal dispersion.

A solution in the context of the present invention is to be understood as a single-phase mixture in which one substance—the solute—is homogeneously distributed in a second substance—the solvent. In the context of the present invention, a dispersion is to be understood as a two-phase mixture in which a first phase with the dispersed substance, the so-called discontinuous phase, is finely distributed, in particular homogeneously distributed, in a second phase, the dispersant or continuous phase. The transition from solutions to dispersion is fluid and cannot be strictly demarcated from one another; for example, colloidal solutions cannot be clearly assigned to either solutions or dispersions. Even in the case of “solutions” of high-polymer macromolecules, it is not possible to determine unambiguously whether a solution or dispersion is present. In the context of the present invention, therefore, a sol is preferentially understood to mean a solution or a finely divided, i.e., colloidal dispersion.

With regard to performing the method according to the present invention in detail, it is envisaged in particular that the precursor sols are mixed with each other and supplied to a reaction apparatus. It is further preferred if the precursor sols are mixed and subsequently supplied to a reaction apparatus, in particular immediately after mixing. In this context, it is again further preferred if the precursor sols, in particular immediately after mixing, are supplied to a reaction apparatus in the form of drops, in particular dropwise.

Here, according to the invention, it is particularly preferred if the, in particular mixed, precursor sols are sprayed or dropped, in particular dripped, into the reaction apparatus.

It has further proved to be particularly advantageous if the precursor sols are supplied into a reaction apparatus to which pressure can be applied in the form of drops, in particular dropwise, preferably are sprayed or dropped, more preferably dripped.

Furthermore, it has been well proven in the context of the present invention if the precursor sols for producing the lyogel are continuously mixed with each other, in particular by means of a feed system, preferably by means of a two-substance feed system.

Based on this procedure according to the invention, it can be achieved in particular that the two precursor sols are mixed with each other so uniformly and homogeneously that gel formation or gelation occurs in a controlled manner, in particular after a controllable or adjustable duration, preferably of a few seconds.

In this context, the method according to the invention is preferably designed in such a way that gel formation or gelation occurs or starts in particular at the moment when the precursor sols mixed with each other are to be supplied to the apparatus, preferably in the form of drops or dropwise, or in particular sprayed or dropped, preferably dripped, i.e. at the moment when the precursor sols enter the apparatus via an inlet opening, in particular a nozzle. Thus, at the moment of droplet formation, both the shape and the size of the formed lyogel particles can be reliably controlled and adjusted due to the onset of gelation. According to the invention, this forms in particular the basis for the production of a lyogel which is uniform with respect to its particle size distribution and which, starting from its in particular dropwise supply into the reaction apparatus, is preferably configured to be spherical or spherical. On this basis, it is likewise possible to generate in particular spherical or ball-like aerogel particles, which is also preferably provided within the scope of the present invention.

According to a preferred embodiment of the present invention, it has been well proven if the production of the lyogel is carried out at atmospheric pressure or at only slightly elevated pressures, in particular at a pressure in a range of less than 40 bar, in particular less than 30 bar, preferably less than 20 bar, more preferably less than 10 bar, particularly preferred atmospheric pressure, i.e., about 1 bar. It is even further preferred in the context of the present invention if producing the lyogel is carried out at a pressure in a range of 1 to 40 bar, in particular 1 to 30 bar, preferably 1 to 20 bar, more preferably 1 to 10 bar. In the context of the present invention, the aforementioned preferred pressures or pressure ranges are to be understood as absolute pressures or pressure ranges.

Accordingly, it has been well proven within the scope of the present invention if the production of the lyogel is carried out in an apparatus that can be pressurized, in particular an autoclave, for example by supplying the precursor sol to the autoclave.

Furthermore, it has proved advantageous with regard to lyogel formation if the production of the lyogel is carried out under a controlled atmosphere, in particular under a CO₂, N₂ or Ar atmosphere or an atmosphere consisting of a mixture of these gases, if necessary in combination with further gases or substances. It has been well proven in particular if CO₂ and/or N₂ are used, if necessary in combination with further gases or substances. Usually CO₂, mixtures of CO₂ and N₂ or mixtures of N₂ and ammonia (NH₃) are used as process medium or controlled atmosphere. In the context of the present invention, a substance is in particular understood to mean a chemical substance, i.e. a chemical compound or element with specific physical or chemical properties.

With regard to the provision of the precursor sols, it is now usually preferred in the context of the present invention if the precursor sols are provided separately from each other.

Furthermore, it has been well proven for the method according to the invention if the precursor solutions for producing the lyogel are dosed separately from each other and are continuously fed to each other.

The method according to the invention is thus characterized in particular in that the precursor sols used, which comprise from each other different pH values, are kept separately from each other and are also metered separately from each other before they are then continuously fed to each other in metered form, in particular via a feed system, preferably a two-substance feed, and are mixed with each other during this process or subsequently, in particular in a mixing section. Based on this procedure, a particularly homogeneous and uniform mixing of the precursor sols can be achieved, which in particular can be further positively influenced by the fact that static mixing elements are arranged within the mixing section, which contribute to a thorough swirling and mixing of the precursor solutions in the mixing section.

For the formation of a homogeneous, uniform gel, it has proved to be particularly important in the context of the present invention to control the rate of gel formation on the basis of the pH value which the, in particular mixed, precursor sols comprise.

In this context, it has been particularly well proven if the first precursor sol comprises an acidic pH value and the second precursor sol comprises a basic pH value.

The specific pH values to which the precursor sols are adjusted for this purpose can vary within wide ranges of the acidic or basic pH value range. However, particularly good results are obtained in the context of the present invention if the acidic pH value is in a range of pH 0 to 6, in particular pH 1 to 4, preferably pH 1.5 to 2.5. Likewise, it has been particularly well proven for the method according to the invention if the basic pH is in a range of pH 7 to 13, in particular pH 8 to 12, preferably pH 9 to 11.

Ultimately, the decisive factor for the method according to the invention is in particular which pH value the precursor sols mixed with each other comprise. In this context, it has proved particularly well if the precursor sols mixed with each other comprise a pH value in a range from pH 4.5 to 9.5, in particular pH 5 to pH 9, preferably pH 5.3 to 8.5.

It is even more preferably the case if the precursor sols mixed with each other comprise a weakly acidic pH, in particular in a range from pH 4.5 to 6.8, preferably pH 5 to 6.5, or a weakly basic pH, in particular in a range from pH 7.5 to 9.5, preferably pH 7.8 to 9.

Finally, in the context of the method according to the invention, particularly good results are obtained if the precursor sols mixed with each other comprise a weakly acidic pH, in particular in a range from pH 4.5 to 6.8, preferably pH 5 to 6.5.

In this context, it may additionally be provided within the scope of the present invention that a buffer is added to the, in particular with each mixed, other precursor sols. In this context, a buffer is understood to be a mixture of substances whose pH changes to a much lesser extent on addition of an acid or a base than would be the case in an unbuffered system. By the additional addition of a buffer to the, in particular mixed, precursor sols, an even more precise control of the pH value or an even more efficient stabilization of the pH value, which is present in particular after mixing of the precursor sols, can thus be achieved.

For the pH value ranges mentioned above, it can be observed that a highly transparent lyogel, or in particular hydrogel, is formed, wherein this comprises in particular additional elastic properties in the basic pH value range. In contrast, gels formed in the acidic range are preferentially characterized by higher strength or reduced elasticity compared to gels formed in the basic range. For aerogels obtained from these lyogels, it has been shown that lyogel particles formed in both the basic and acidic regions result in highly porous gels that comprise exemplary porosities of 95.7% and more. Furthermore, it can be observed that in particular aerogels from lyogel particles formed in the acidic state comprise a larger specific surface area according to BET as well as a higher pore volume compared to aerogels from lyogels formed in the basic state, wherein a difference of almost a factor of 2 can be determined here with regard to the BET surface area and a difference of a factor of 1.3 with regard to the pore volume.

Furthermore, particularly good results are obtained for the method according to the invention if producing of the lyogel is carried out at temperatures above 50° C., in particular 60° C., preferably 70° C., more preferably 80° C.

At the above-mentioned pH values, pressures and temperatures, gel formation can be achieved particularly rapidly and also in a controlled manner, whereby, for example, almost spherical lyogels can be obtained which are dimensionally stable and can also retain their shape in the further course of the method.

In accordance with the present invention, it has proved particularly useful if the production of the lyogel from the mixed precursor sols takes place within less than 60 seconds, in particular less than 30 seconds, preferably less than 20 seconds, more preferably less than 10 seconds, further preferably less than 5 seconds.

Likewise, it is preferentially provided in the context of the present invention that the production of the lyogel from the mixed precursor sols takes place within more than 0.1 seconds, in particular more than 0.5 seconds, preferably more than 1 second. Very particularly advantageous for the method according to the invention are time periods for producing the lyogel in a range from 1 to 5 seconds.

According to a preferred embodiment of the present invention, it is also preferably provided that the production of the lyogel and the conversion of the lyogel into an aerogel are performed continuously or quasi-continuously. Indeed, it can be achieved on the basis of the method according to the invention in particular that the process times, in particular the times of the individual method steps, are shortened in such a way that a continuous or at least quasi-continuous production of aerogels, in particular silica aerogels, is possible. The production can be carried out either as a one-pot process, i.e. in a reaction apparatus, in particular an autoclave, or in successive apparatuses, in particular several autoclaves.

Turning now to the composition and nature of the precursor sol, it is usually preferred in the context of the present invention if the precursor sol is in the form of a solution or dispersion.

Here, in the context of the present invention, a precursor is to be understood as a precursor substance from which the desired target compound, in particular an SiO₂ network, is formed by chemical reaction, in particular, for example, by hydrolysis or solvolysis and subsequent condensation.

Accordingly, in principle, all compounds capable of configuring a gel can be used as precursors within the scope of the present invention.

In this context, it is particularly preferred according to the present invention if the precursor sols contain silicon-based precursors. With regard to the composition of the precursor sols used in accordance with the invention, it has further proved advantageous if the precursor sols contain silicon in amounts in a range from 3 to 20 wt. %, in particular 4 to 15 wt. %, preferably 5 to 10 wt. %, based on precursor sols.

In this sense, supersaturated precursor solutions are preferably used in the context of the present invention, since it has been observed that sufficiently rapid gel formation can be achieved in particular when supersaturated solutions are used. For example, the saturation concentration of a suitable precursor such as monomeric silicic acid at pH=7 is approximately 0.002 mol/l. In contrast, according to the invention, it is preferred if the concentration of silicon in the exemplary silicic acid-based precursor sol is between 0.83 mol/l (5 wt. %) and 1.66 mol/l (10 wt. %). Mathematically, this results in a supersaturation of more than 400 times.

In the context of the present invention, particularly good results are now obtained if the precursors are selected from the group of silicas, in particular colloidal silicic acid, silicic sols, silica sols, silanes, in particular tetraalkoxysilanes, siloxanes, silicates and mixtures thereof.

On hydrolysis, the compounds mentioned above configure a silica network, optionally organically modified, which is excellently suited for producing silica aerogels.

Particularly good results are obtained in this context if the precursor is selected from silicic acids, in particular colloidal silicic acid, silica sols and tetraalkoxysilanes, preferably tetraetoxysilanes and/or tetrametoxysilanes. It is particularly preferred if the precursor is a silicic acid.

In a preferred embodiment of the present invention, it has proved particularly well if silicic acid is used as precursor for the acid-adjusted precursor sol, which is produced, for example, from sodium silicate using ion exchange and in particular comprises a solids content of up to 10 wt. %. The pH value of such a silicic acid solution is pH 3.5 to 2.0. For improved storage stability, the pH value can also be lowered further, e.g. with hydrochloric acid to a value of about pH 1.

According to the invention, it is even more preferred for the basic precursor sol if the precursor is a basic silica solution which can be produced, for example, from sodium silicate and can then be adjusted to pH values of 8.5 to 9.5 with a base, e.g. sodium hydroxide solution and/or ammonia. The solids content can preferably be up to 10 wt. %.

Alternatively, it has also proved particularly advantageous if a water glass solution based on sodium and/or potassium water glass, in particular with an SiO₂ content of 10 wt. %, is used as precursor for the basic adjusted precursor sol.

Also, it may preferably be provided within the scope of the present invention that for the basic adjusted precursor sol, as an aqueous colloidal suspension, nearly ball-like polysilicic acid molecules with 10 to 40 wt. % SiO₂, in particular with a pH in a range of pH 8 to 10, are used.

Last but not least, it has also proved particularly suitable for the method according to the invention if an alkoxysilane solution, in particular prehydrolyzed and partially condensed, is used as precursor for the basic precursor sol, preferably with a solids content of between 10 and 20 wt. %. Such a solution is in particular a partially aqueous solution, wherein the water content can be adjusted depending on the alkoxysilane used and is preferably 1:1 to 2:1 in the molar ratio H₂O:the number of alkoxy groups. For this preferred embodiment of the present invention, it has also been shown to be advantageous if surfactants, for example cetyl trimethyl ammonium chloride, are added to the basic precursor sol, in particular since these can increase the solubility of the partly organic alkoxysilane solution in the acidic precursor sol, for example in an aqueous acidic silica solution.

In the context of the present invention, it is further customary for the precursor sols each to comprise at least one solvent or dispersant.

In this context, it has been well proven if the solvent or dispersant is selected from alcohols, in particular methanol, ethanol, isopropanol, ethers, dimethyl sulfoxide (DMSO), N,N-dimethyl formamide (DMF), acetone, propylene carbonate, ethyl acetate, water and mixtures thereof.

Particularly good results are obtained in this context if the solvent or dispersant consists of alcohols, in particular methanol, ethanol, isopropanol, water and mixtures thereof. In particular, mixtures of organic solvents and water, especially ethanol and water, are preferably used in the context of the present invention, since, on the one hand, the water causes rapid hydrolysis and condensation of the precursor compounds and, on the other hand, a proportion of organic solvents promotes removal of the solvent or dispersant from the pores of the lyogel.

The use of organic solvents such as ethanol, acetone, dimethyl sulfoxide for gel synthesis also offers the possibility of using hydrophobing agents such as trimethylsilanol, methyltriethoxysilane, diphenylsilanediol, hexamethyldisilazane, etc., also directly during the gelation process.

According to the invention, for producing silica aerogels or lyogels, in particular, precursor solutions based on preferably silica sols, colloidal silicic acids and silicic acid tetraethylesters are first prepared and provided. In the case of the silicic sols and the silicic acid, the precursor solutions are pre-silicified water glass (polysilicic acids) with a varying degree of silicification and reduced alkali content. The monosilicic acids, which are generally prepared using ion exchange, are predominantly present as di- and tri-silicic acids due to condensation processes.

The silica sols, on the other hand, typically comprise a much higher degree of silicification and generally have a primary particle size between 5 and 40 nm. Compared to the silicic acid tetraethylesters (TMOS, TEOS) and potassium silicates often used in aerogel production, the use of silica sols and silicic acids offers the possibility of selective control of the gelation and subsequent aging process of the lyogels or in particular hydrogels. In the silica sols and silicic acids, the silica nanoparticles are generally present in solutions stabilized via ionic charges.

One way of obtaining polysilicas with a low water content and a higher proportion of organic solvents is to use alcoholic silica tetraethylesters, but these must first be prehydrolyzed to ensure sufficiently rapid polycondensation of the monosilicic acid that forms. In order to increase the amount of monosilicic acid in the precursor solution or sol, aqueous silica solutions can be added after the silicic acid tetraethylesters have been hydrolyzed, whereupon gel formation can subsequently be initiated to produce an organogel with a low water content.

As has been pointed out, it is preferred in accordance with the invention if the precursor sols are supersaturated sols. In this context, it has further been found to be advantageous if the precursor sols, in particular supersaturated ones, comprise a certain solids content, so that a dimensionally stable gel is configured. The solids content of the sol is to be understood as the proportion of the sol which remains after removal of all liquid components.

It has proved well in the context of the present invention if the precursor sols, in particular individually or independently of each other, comprise a solids content of at least 2 wt. %, in particular 2.5 wt. %, preferably 3 wt. %, more preferably 4 wt. %, in particular 5 wt. %, based on each of the sols.

According to a preferred embodiment of the present invention, it is provided in this context that the precursor sols, in particular individually or independently of each other, comprise a solids content in the range from 2 to 30 wt. %, in particular 2.5 to 20 wt. %, preferably 3 to 15 wt. %, preferably 4 to 10 wt. %, particularly preferably 5 to 9 wt. %, based on each the sol.

With solids contents in the above-mentioned range, dimensionally stable lyogels can be obtained particularly quickly, which also comprise the desired high pore content.

Within the scope of the present invention, it may be provided that the precursor sols or, in particular, at least one of the precursor sols contains a hydrophobing agent, in particular a silanizing agent. The use of a hydrophobing agent, in particular a silanizing agent, in the precursor sol or precursor sols leads in particular to an incorporation of hydrophobic groups into the framework of the lyogel. This, in turn, results in a more elastic gel structure, which, for example, is significantly more resilient during solvent exchange or also during drying to form an aerogel than, for example, a pure SiO₂ structure.

In the context of the present invention, it is preferred if the hydrophobing agent is selected from organosilanes, in particular monoorganosilanes, diorganosilanes, triorganosilanes, silazanes, silanols, in particular monoorganosilanols, diorganosilanols, and mixtures thereof. In the context of the present invention, organosilanes or organosilanols are understood to mean silanes or silanols with organic groups, in particular hydrophobic organic groups, such as alkyl, alkenyl or aryl.

If a silane is used as a hydrophobing agent in the context of the present invention, its chemical nature can likewise vary over a wide range. However, particularly good results are obtained if a silane of the general formula I

R¹ₙSiR²₄₋ₙ (I)

with

n=1 to 3, in particular 1 or 2, preferably 1;

R¹═C₁- to C₃₀-alkyl and/or C₆- to C₃₀-aryl,
in particular C₂- to C₂₀-alkyl and/or C₆- to C₂₀-aryl,
preferably C₃- to C₂₀-alkyl and/or C₆- to C₂₀-aryl,
more preferably C₄-C₁₅-alkyl and/or C₆-C₁₅-aryl,
even more preferably C₅-C₁₂-alkyl and/or C₆-C₁₂-aryl,
particularly preferred C₅-C₁₂-alkyl;

R²=halide, in particular chloride, bromide and/or iodide,
OX with X=hydrogen, alkyl, aryl, polyether and/or carboxylic acid derivative,
   in particular alkyl, preferably C₁- to C₈-alkyl, preferably C₂- to C₄-alkyl;

is used.

Particularly good results are obtained in the context of the present invention if the hydrophobing agent is selected from organochlorosilanes, in particular monoorganochlorosilanes, diorganochlorosilanes, triorganochlorosilanes, methoxyorganosilanes, in particular trimethoxyorganosilanes, dimethoxydiorganosilanes, methoxytriorganosilanes, ethoxyorganosilanes, in particular triethoxyorganosilanes, diethoxydiorganosilanes, ethoxytriorganosilanes, hexamethylenedisilazane, trimethylsilanol, diphenylsilanediol, phenyltriethoxysilane, trimethylisopropenoxysilane and mixtures thereof. The early use of hydrophobizing agents, in particular silanizing agents, prior to gel formation can influence the network structure that forms and control the pore sizes that are configured. In addition, elasticization of the gel network can be achieved by incorporating mono- and difunctional silanizing agents. Both can be used, for example, to accelerate a subsequent solvent exchange of the produced hydrogel.

In the context of the present invention, it is preferred—as previously stated—if the, in particular mixed, precursor sols are supplied into an apparatus, in particular one to which pressure can be applied, in the form of droplets, in particular are sprayed or dropped, preferably dripped.

By supplying the precursors in the form of droplets, for example by dropping or ispraying them into the, in particular a pressurizable, apparatus, for example an autoclave, it is possible to synthesize aerogels with an almost circular cross section. Depending on the adjustment of the drop rate, i.e. the dosage of the precursor sol, or the supply conditions of the, in particular mixed, precursor sols into the apparatus, almost spherical and/or also cylindrical particles can be obtained. The nozzle can be designed, for example, in the form of a slotted nozzle or a capillary and the, in particular mixed, precursor sols can be supplied to the apparatus by pumps, in particular high-pressure pumps.

The droplet size in this case can be controlled in particular by the selected nozzle orifice and/or the gelation speed and, when using a 2 mm nozzle, typically lies in a range between 0.5 and 5 mm. By selecting a smaller nozzle, the gel particle size can be further reduced. Preferentially, the forming particles comprise a ball-like shape and retain the shape during the subsequent method steps.

The supply of the, in particular mixed, sols in the form of droplets into the, in particular pressurizable, apparatus thus makes it possible to obtain virtually spherical lyogel particles which also remain dimensionally stable during the further procedure. This makes ball-like aerogels accessible, which comprise improved mechanical properties compared to the state of the art and can form denser ball packings, and are consequently more suitable as thermal insulation materials, both in loose filling and, for example, for incorporation into insulating plaster systems.

According to a particular embodiment of the present invention, it may be provided that the precursor sols are pre-gelled before being supplied to the, in particular pressurizable, apparatus. Pre-gelation or pre-condensation is understood to mean the production of larger network structures and aggregates, wherein, however, a continuous spatial network is not yet obtained. The pre-gelled, in particular with each other mixed, sols are still flowable and can accordingly be sprayed or dropped into an apparatus. Pre-gelation can be achieved, for example, by adjusting the path or mixing distance until the precursor sol is supplied to the reaction apparatus. The duration of the pre-gelation depends on the type and concentration of the precursors, the pH value and/or the size and shape of the lyogel or aerogel particles, etc., to be formed.

In addition to the gelation, which is preferably controlled or initiated by pH regulation according to the invention, the gelation, in particular also a pre-gelation, of the precursor sols can be further influenced and/or in particular the hydrolysis and condensation rate of the silica sol can be accelerated by electrolyte additives, for example polyvalent metal salts, and denaturing solvents such as ethanol and acetone. The polycondensation ability of the precursor, for example in particular of the silica, represents here the rate-determining step in the formation of a dimensionally stable, three-dimensional network. It has been shown that the use of ethanol and/or electrolytes makes it possible to selectively gel the precursor sols or, in particular, silicic acids and/or silicic sols. Organogels with 66 vol % ethanol content can be synthesized in this way. These are characterized by a high hydrolysis and condensation rate and the production of a dimensionally stable organogel network.

Preferred silica tetraethylesters such as tetraethyl orthosilicate (TEOS) and tetramethyl orthosilicate (TMOS) offer—as previously stated—the possibility of producing organogels with low water content, which can significantly accelerate subsequent solvent exchange, for example. To accelerate the gelation rates of these precursor sols, prehydrolysis of the metal alcoholates can be performed, which can be carried out in both acidic and basic pH ranges, wherein the configuration of three-dimensional networks is favored in the acidic one.

Mineral acids such as hydrochloric acid can be used as catalysts for the pre-gelation or pre-condensation. In particular, the precondensation can be accelerated by the use of catalysts such as organic acids, in particular acetic acid, inorganic acids, such as hydrochloric acid, or Lewis acids, such as titanium tetrabutanolate.

An upstream hydrolysis of the silicic acid esters can be carried out in the basic pH range using, for example, ammonia at a pH of 9 to accelerate a downstream hydrolysis.

Precondensation with acetic acid at pH values of 3.5 to 4.5 and stoichiometric content of water to tetraethyl orthosilicate of 2.5 to 3.5 produces precursor sols within a few hours, which can be gelled by pH shifts and addition of water. In addition, it is possible to shift the pH of these pre-condensed tetraethyl orthosilicate solutions or sols into the basic range.

According to a preferred embodiment of the present invention, the present invention relates to a previously described method, wherein
(a) in a first method step at least two precursor sols, preferably two precursor sols, are mixed with each other, wherein a first precursor sol comprises an acidic pH or a basic pH and a second precursor sol comprises a pH value different from the first precursor sol, and
(b) in a second method step following the first method step (a) are mixed with each other and, in particular immediately after mixing, are supplied into a reaction apparatus, preferably in the form of droplets, more preferably dropwise, wherein a particulate lyogel is obtained.

To this particular embodiment of the method according to the invention, all advantages and particularities as well as features mentioned before can be equally applied.

In the context of the present invention, it may further be provided that the lyogel is aged after its production. If the lyogel is aged, it is preferred if the lyogel is aged for a period of 1 minute to 1 hour, in particular 5 to 50 minutes, preferably 10 to 45 minutes, more preferably 15 to 40 minutes. Aging the lyogel in particular solidifies the gel structures so that these are significantly more stable and resistant in the subsequent drying process.

Preferably, the aging of the lyogel is carried out at the temperature at which the production of the lyogel takes place. In this context, it is preferred if the aging of the lyogel is carried out at temperatures above 50° C., in particular 60° C., preferably 70° C., more preferably 80° C. In accordance with the invention, particularly good results are obtained here if the aging of the lyogel is carried out in the temperature range from 50 to 150° C., in particular 60 to 140° C., preferably 70 to 130° C.

The pressures at which the aging process is carried out can vary over a wide range. However, it is particularly preferred in the context of the present invention if the aging of the lyogel is carried out at the same pressure as that used in the production of the lyogel.

In the context of the present invention, it is thus possible to reduce the aging time of the lyogel, in particular hydrogel, which usually takes at least 2 hours, to about 30 minutes.

Within the scope of the present invention, it may be provided that after producing the lyogel, in particular following method step (b), a solvent exchange is performed, in particular in a third method step (c). A solvent exchange may be necessary in particular to facilitate subsequent drying of the lyogel to form the aerogel.

In particular, the water added to the precursor sols is difficult to remove from the usually hydrophilic network, in particular SiO₂ network, of the lyogel in a drying process by adding thermal energy. This is also true if the lyogel has been hydrophobized. The lyogel particles, in particular hydrogel particles, which are produced and in particular have a circular cross-section, thus generally have a water content that makes drying difficult. However, it has been shown that water reduction in the precursor sols used initially, in particular silicic acid solutions, can significantly accelerate the drying rates of the lyogel particles depending on the organic solvent added. Alternatively or additionally, a subsequent drying process can then be facilitated using an exchange of the solvent, in particular the water, for a more volatile solvent.

Thus, in particular in order to lower the water content of the previously prepared lyogels, in particular hydro- or organogels, prior to the actual drying step, it may be necessary to subject the gels to a solvent exchange, for example by covering the particles with an organic solvent.

In this context, it is preferred if the lyogel is brought into contact with a liquid or gaseous organic solvent to carry out the solvent exchange.

The organic solvent can be supplied in gaseous form to the reaction chamber and then displaces water or other organic solvents stored in the pores of the lyogel. Similarly, it is also possible for the lyogel to be brought into contact with the liquid solvent, in particular to be dispersed in it or to be covered with it, and thus to achieve extensive solvent exchange, for example, by multiple covering with solvents and removal of the mixture of water and/or organic solvents. Preferentially, the solvent with which the solvent exchange is performed is soluble in a drying gas, in particular carbon dioxide. In this way, it is possible, for example, to carry out supercritical drying with carbon dioxide much faster and more gently.

In the context of the present invention, it is also preferred if the solvent exchange in particular reduces the water content of the lyogel to a value of less than 30 wt. %, in particular less than 20 wt. %, preferably less than 15 wt. %, more preferably less than 10 wt. %, based on the lyogel. By lowering the proportion of in particular water in the lyogel, a target-oriented and gentle drying with carbon dioxide in the supercritical range becomes possible.

Within the scope of the present invention, it is preferentially provided that the solvent exchange, in particular the bringing into contact of the lyogel with the solvent, is performed at atmospheric pressure or moderately elevated pressure, in particular in a range from 1 to 40 bar. Surprisingly, it has been shown that pressures just above the vapor pressures of the solvents used at temperatures in particular above 80° C. are already sufficient to achieve the solvent exchange. Preferentially, in the context of the present invention, either liquid solvent or a mixture of water and organic solvent is removed from the apparatus during solvent exchange, or the gaseous phase contaminated with water is at least partially removed from the reactor and new solvent is supplied to the reactor in a gaseous state in order to obtain solvent exchange that is as complete as possible.

In the context of the present invention, therefore, particularly good results are obtained if the solvent exchange, in particular the bringing into contact of the lyogel with the solvent, is carried out at atmospheric pressure or moderately elevated pressures, in particular at pressures in a range from 0 to 40 bar, preferably 0 to 30 bar. In this context, it has further been well proven if the solvent exchange is carried out under a controlled atmosphere, in particular under a CO₂, N₂ or Ar atmosphere or an atmosphere consisting of a mixture of these gases, as is also preferentially provided for lyogel formation in particular.

Now, with regard to the temperature range within which the solvent exchange is carried out, it has been well proven if the solvent exchange is carried out at elevated temperature. In this context, particularly good results are obtained if the solvent exchange, in particular the bringing into contact of the lyogel with the solvent, is carried out at temperatures above 70° C., in particular above 80° C., preferably above 90° C., more preferably above 100° C., particularly preferably above 110° C. By means of a high temperature, especially at the preferably applied pressures, it is surprisingly possible to achieve the most rapid and complete solvent exchange possible.

In this context, it may equally be envisaged that the solvent exchange, in particular the bringing into contact of the lyogel with the solvent, is carried out at temperatures in the range of 70 to 180° C., in particular 80 to 160° C., preferably 90 to 150° C., more preferably 100 to 140° C., preferentially 110 to 130° C.

Now, as far as the organic solvent used in the course of the solvent exchange is concerned, it has been well proven if the solvent is selected from the group of hydrophilic organic solvents, hydrophobic organic solvents and mixtures thereof. It is particularly preferred in the context of the present invention if the organic solvent is soluble in carbon dioxide.

In the context of the present invention, an organic solvent is to be understood as a solvent or dispersant which comprises organic groups.

Now, as far as the organic solvent is concerned, it has been well proven if the organic solvent is selected from the group of alcohols, ethers, dimethyl sulfoxide, N,N-dimethyl formamide, C₅ to C₈ alkanes and mixtures thereof. Particularly good results are obtained in the context of the present invention if the organic solvent is selected from methanol, ethanol, isopropanol, dimethyl sulfoxide, n-pentane, n-hexane, n-heptane, cyclohexane and mixtures thereof. The aforementioned solvents not only allow solvent exchange and easy subsequent drying to be achieved. The solvents are also ideal for contacting the lyogel with modifying reagents.

In particular, in the context of the present invention, it may also be provided that the organic solvent is brought into contact with the lyogel together with a hydrophobing agent, in particular a silanizing agent. Within the scope of the present invention, it is thus possible to perform hydrophobing, in particular silanization, of the lyogel also during the solvent exchange, so as to subsequently enable simple drying and conversion of the hydrogel into an aerogel. In order to achieve particularly effective hydrophobing, in particular silanization, it is advantageous if, at the start of contacting the organic solvent and the hydrophobing agent with the lyogel, the water content of the lyogel is at least 50 wt. %, in particular at least 60 wt. %, preferably at least 70 wt. %. In this way, rapid hydrolysis and reaction of the reactive groups of the hydrophobing agent, in particular the silanizing agent, is provided.

Now, as far as the chemical nature of the hydrophobing agent is concerned, it has been well proven if the hydrophobing agent is selected from organosilanes, in particular, monoorganosilanes, diorganosilanes, triorganosilanes, silazanes, silanols, in particular, monoorganosilanols, diorganosilanols and mixtures thereof.

If a silane is used as a hydrophobing agent in the context of the present invention, its chemical nature may vary over a wide range. However, particularly good results are obtained if a silane of the general formula I

R¹ₙSiR²₄₋ₙ (I)

with

n=1 to 3, in particular 1 or 2, preferably 1;

R¹═C₁- to C₃₀-alkyl and/or C₆- to C₃₀-aryl,
in particular C₂- to C₂₀-alkyl and/or C₆- to C₂₀-aryl,
preferably C₃- to C₂₀-alkyl and/or C₆- to C₂₀-aryl,
more preferably C₄-C₁₅-alkyl and/or C₆-C₁₅-aryl,
even more preferably C₅-C₁₂-alkyl and/or C₆-C₁₂-aryl,
particularly preferred C₅-C₁₂-alkyl;

R²=halide, in particular chloride, bromide and/or iodide,
OX with X=hydrogen, alkyl, aryl, polyether and/or carboxylic acid derivative,
   in particular alkyl, preferably C₁- to C₈-alkyl, preferably C₂- to C₄-alkyl;

is used.

Particularly good results are obtained in this context if the hydrophobing agent is selected from organochlorosilanes, in particular monoorganochlorosilanes, diorganochlorosilanes, triorganochlorosilanes, methoxyorganosilanes, in particular trimethoxyorganosilanes, dimethoxydiorganosilanes, methoxytriorganosilanes, ethoxyorganosilanes, in particular triethoxyorganosilanes, diethoxydiorganosilanes, ethoxytriorganosilanes, hexamethyldenisilazane, trimethylsilanol, diphenylsilanediol, phenyltriethoxysilane, trimethylisopropenoxysilane and mixtures thereof.

Thus, the hydrophobing agents preferably used during solvent exchange correspond to the hydrophobing agents which are also used during hydrophobing or silanization of the, in particular mixed, precursor sols. In the context of the present invention, it is particularly preferred if both a hydrophobing agent, in particular a silanizing agent, is added to the precursor sols and further hydrophobing is performed after lyogel formation.

Hydrophobing after producing the lyogel, in particular as part of a solvent exchange or as a separate method step, results in hydrophobing of the pores of the lyogel. During solvent exchange, hydrophobing of the pores, in particular pore silanization, can be achieved with the use of further hydrophobing agents, in particular silanization agents. In this context, it was found in particular that the use of further hydrophobing agents, such as hexamethyldisilazane, can significantly accelerate a required solvent exchange step. For successful silanization, the residual water content of the lyogels should be sufficiently high, preferentially above 50 wt. %, based on the weight of the lyogel.

The pH values of the solutions or dispersion of the hydrophobing agent, in particular the silanization solutions, may vary depending on the hydrophobing agents, in particular silanization agents, used. When using trimethylsilanol, diphenylsilanediol, hexamethyldisilazane and hexamethyldisiloxane as well as other silanols or silanol-forming substances, pH values greater than 8 have been shown to be advantageous. Organic solvents, such as nonpolar alkanes (hexane), aprotic solvents or alcoholic solvents, such as methanol, ethanol, isopropanol, or the like, to which the previously mentioned hydrophobing agents, in particular silanizing agents, are added, can be used as the silanizing solution. The lyogels can be bathed in or covered with the solution or dispersion containing the hydrophobing agent, wherein the contact times are preferentially up to 30 minutes.

Alternatively, the hydrophobing agents, in particular silanizing agents, can also be used in a compressed phase saturated or partially saturated with organic solvent, in particular the CO₂, N₂ and/or Ar atmosphere, preferably a CO₂ phase, wherein the phase can be both a subcritical gas phase and a supercritical phase. Suitable organic solvents include nonpolar solvents, such as hexane, aprotic solvents, such as dimethyl sulfoxide, or alcoholic solvents, such as ethanol. The solvents used can improve the solubility of the hydrophobing agents, in particular the silanizing agents in the compressed CO₂ phase. If the solubility of the hydrophobing agents, in particular the silanizing agents, in the process medium, i.e. the aforementioned gases forming the reaction atmosphere, is sufficient, in particular in the compressed CO₂, the use of organic solvents can be omitted.

In the context of the present invention, it may be provided that the solvent exchange is carried out in several process stages, in particular in 2 to 15, preferably 3 to 10, more preferably 3 to 4, process stages. In this context, it may be provided that the lyogel is brought into contact with the organic solvent several times. Preferentially, it is specified that in each process stage at least part of a mixture of solvent and water or solvent to be replaced is removed from the reactor and new organic solvent is supplied.

In the context of the present invention, it is particularly preferred if the solvent exchange reduces the water content of the lyogel to below 20% by volume, preferably below 15% by volume, preferably below 10% by volume, based on the total volume of solvent or dispersant.

According to a preferred embodiment, the solvent exchange can be carried out by using water-miscible solvents, such as ethanol, methanol, isopropanol and dimethyl sulfoxide. Here, it is shown that the residual water content in the spherical lyogel particles should preferably be reduced to less than 10% by volume before downstream drying is started. Alternatively and equally preferred, hydrophobic organic solvents can also be used for this process step, such as hexane, pentane or cyclohexane, which can displace the water stored in the pores from the lyogel if sufficiently presilanized. The solvent exchange is preferentially carried out in the compressed carbon dioxide. Here, the solvent is metered into the reaction apparatus. Surprisingly, it turns out that solvent exchange can be carried out successfully even if the solvent does not come into contact with the gel particles in liquid form. Rather, it is sufficient if the solvent dissolves in the compressed CO₂ and thus penetrates the gel and displaces the water from the pores.

According to a preferred embodiment of the present invention, the present invention relates to a method for producing aerogel as previously described, wherein
(a) in a first method step at least two precursor sols, preferably two precursor sols, are mixed with each other, wherein a first precursor sol comprises an acidic pH or a basic pH and a second precursor sol comprises a pH value different from the first precursor sol, and
(b) in a second method step following the first method step (a) are mixed with each other and, in particular immediately after mixing, are supplied into a reaction apparatus, preferably in the form of droplets, more preferably dropwise, wherein a particulate lyogel is obtained, and
(c) in a third method step following the second method step (b), solvent exchange and/or hydrophobing of the lyogel is carried out.

The solvent exchange in method step (c) can be carried out over a period of up to 50 minutes, in particular up to 40 minutes, preferably up to 30 minutes. In particular, it is preferred in the context of the present invention if the solvent exchange is carried out over a period of 10 to 50 minutes, in particular 20 to 40 minutes, preferably 20 to 30 minutes.

For the embodiment of the method according to the invention described above, all further embodiments, features and special features mentioned above apply.

In the context of the present invention, it is usually provided that the lyogel is converted into an aerogel by removing the solvent or dispersant, in particular in a subsequent method step (d).

In this context, it may be provided that following solvent exchange and/or hydrophobing of the lyogel, in particular following method step (c), the lyogel is converted into an aerogel. In the context of the present invention, it is preferred if the solvent removal is carried out at an elevated pressure.

Generally, it is envisaged that in order to convert the lyogel into an aerogel, the lyogel is brought into contact with a drying medium, in particular a drying gas or a supercritical medium. Preferably, the drying medium is carbon dioxide. In this context, it may be provided that the lyogel is brought into contact with the drying medium, in particular the drying gas or the supercritical medium, in a continuous or discontinuous manner. In the case of discontinuous contacting, the lyogel is brought into contact in an apparatus with a predetermined amount of the drying medium for a preselected period of time. The solvent-contaminated drying medium is then removed and, if necessary, replaced with fresh drying medium until the desired degree of dryness is achieved. In the case of continuous contacting of the lyogel with the drying medium, also known as continuous drying, the lyogel is swept over or flowed through by the drying medium in an apparatus until the desired degree of dryness is achieved.

In this context, particularly good results are obtained if the removal of the solvent is carried out at pressures of more than 50 bar, in particular more than 60 bar, preferably more than 80 bar, more preferably more than 100 bar. Similarly, it may be envisaged that the removal of the solvent is carried out in the range of 50 to 180 bar, in particular 80 to 175 bar, preferably 100 to 170 bar, more preferably 110 to 165 bar, in particular preferably 120 to 160 bar.

Now, with regard to the temperatures at which the removal of the solvent is carried out, it has been well proven if this is carried out at elevated temperatures.

Usually, the removal of the solvent is carried out at temperatures above 50° C., in particular above 55° C., preferably above 60° C.

In this context, it may equally be provided that the removal of the solvent is carried out at temperatures in the range of 50 to 160° C., in particular 70 to 160° C., preferably 90 to 150° C., more preferably 100 to 140° C., particularly preferred 110 to 130° C.

By removing the solvent at the aforementioned pressures and temperatures, an aerogel can be obtained particularly rapidly, in particular by supercritical drying using CO₂. Typically, in the context of the present invention, it is envisaged that the solvent is removed from the lyogel within 10 to 50 minutes, preferably 20 to 30 minutes.

Subject-matter of the present invention is preferably a method for producing an aerogel as previously described, wherein
(a) in a first method step at least two precursor sols, preferably two precursor sols, are mixed with each other, wherein a first precursor sol comprises an acidic pH or a basic pH and a second precursor sol comprises a pH value different from the first precursor sol, and
(b) in a second method step following the first method step (a) are mixed with each other and, in particular immediately after mixing, are supplied into a reaction apparatus, preferably in the form of droplets, more preferably dropwise, wherein a particulate lyogel is obtained, and
(c) in a third method step following the second method step (b), solvent exchange and/or hydrophobing of the lyogel is carried out, and
(d) in a fourth method step following the third method step (c), the lyogel is converted into an aerogel using removal of the solvent or dispersant.

On this particular and preferred embodiment of the present invention, all previously mentioned process features and embodiments, in particular also advantages and special features, can be read without limitation.

Now, as far as the total duration of the previously described method is concerned, the method according to the invention is usually carried out with a total duration over the method steps (a) to (d) with realization of the method step (c) in a period of 1 to 2 hours, preferably 1 to 1.5 hours.

In this context, the method according to the invention can be carried out either as a one-pot synthesis or process, i.e. in an autoclave. Equally, however, it is also possible for the individual steps to be carried out in multiple, serially connected apparatuses, in particular autoclaves. The method according to the invention can be carried out in particular from the time the mixed precursor sols are supplied into a reaction apparatus under a special atmosphere, in particular a CO₂ atmosphere, and optionally at an elevated pressure. However, it is preferred if at least the lyogel formation is carried out at only low pressure, preferably at atmospheric pressure.

Preferentially, the drying of the particles is carried out in supercritical CO₂. The drying time of the obtained spherical gel particles with a size of 0.5 to 5 mm can be reduced to 10 to 60 minutes by the method according to the invention with hydrophobing of the lyogels.

In particular, by feeding compressed carbon dioxide as a drying medium, the gas flow can be used for targeted continuous drying of the organogels, and single-stage aerogel particle generation, i.e. in a reactor vessel or reactor, can be ensured.

Due to the spherical particle shape and typical particle diameters between 0.5 and 5 mm, supercritical drying can be carried out in a time window of up to 30 minutes at a pressure of 120 bar and a temperature of 60 to 120° C.

The single FIGURE illustration shows a cross-section of an apparatus according to the invention for carrying out the method according to the invention.

Further subject-matter of the present invention according to a second aspect of the present invention is an aerogel, in particular obtainable according to the methods previously described, wherein the aerogel is in the form of particles with an in particular substantially circular cross-section.

As previously described, the aerogels according to the present invention are characterized by an in particular circular cross-section, which on the one hand significantly increases the mechanical load-bearing capacity and on the other hand significantly increases the ability to produce dense sphere packings.

In the context of the present invention, it is usually provided that the aerogel particles are spherical or cylindrical.

Because of their shape, the aerogels according to the invention offer advantages in processing. For example, the spherical aerogels are much easier to mix into powder mixtures. Due to their improved flowability, higher strengths under uniaxial compressive loading and higher packing density compared to conventional aerogel powders, which are based on shapeless or cubic particles, the preferably spherical aerogels according to the invention can be preferentially used in powder blends or powder mixtures, such as thermal insulation plasters.

As far as the particle size of the aerogel particles is concerned, these can naturally vary over a wide range. However, it has been well proven if the aerogel comprises particle sizes in the range of 0.1 to 10 mm, in particular 0.2 to 8 mm, preferably 0.3 to 7 mm, more preferably 0.5 to 5 mm. For determination of the particle sizes, it is in particular suitable to analyze the particles using sieves and, for smaller particles in the range below 1 mm, using light microscopy.

Similarly, it may be provided within the scope of the present invention that the aerogel particles comprise a monodisperse particle size distribution.

However, it is also possible within the scope of the present invention that the aerogel particles comprise a polydisperse particle size distribution. In particular, the particle size distribution can be selectively controlled by varying the conditions of spraying or dropping into the reactor.

The aerogel particles according to the invention are highly porous solids. Typically, the aerogel comprises a porosity of more than 90%, in particular of more than 91%, preferably of more than 93%.

Similarly, it may be envisaged that the aerogel comprises a porosity of 90 to 96%, in particular 91 to 95%, preferably 93 to 94%. The porosity of the aerogel according to the invention is preferably determined using mercury porosimetry.

Furthermore, the aerogels according to the invention comprise high internal surface areas. Thus, it may be provided that the aerogel comprises a BET surface area of at least 500 m²/g, in particular 600 m²/g, preferably 650 m²/g, more preferably 700 m²/g, particularly preferred 800 m²/g.

Similarly, it may be provided that the aerogel comprises a BET surface area in the range of 500 to 1,000 m²/g, in particular 600 to 1,050 m²/g, preferably 650 to 1,000 m²/g, more preferably 700 to 950 m²/g, particularly preferred 800 to 900 m²/g. To determine or calculate the BET surface area, the nitrogen adsorption of the aerogel particles was investigated and the results in this regard were used for the BET calculations.

Now, as far as the thermal conductivity of the aerogel is concerned, it can vary in wide ranges. Usually, however, in the context of the present invention, the aerogel comprises very low thermal conductivities. Particularly good results are obtained if the aerogel comprises a thermal conductivity of at most 0.025 W/mK, in particular at most 0.022 W/mK, preferably 0.020 W/mK, more preferably 0.019 W/mK.

Typically, the aerogel comprises a thermal conductivity in the range of 0.012 to 0.025 W/mK, in particular 0.013 to 0.022 W/mK, preferably 0.014 to 0.020 W/mK, more preferably 0.015 to 0.019 W/mK.

Furthermore, it may be provided in the context of the present invention that the aerogel comprises a density in the range of 0.01 to 0.60 g/cm³, in particular 0.11 to 0.55 g/cm³, preferably 0.12 to 0.50 g/cm³, more preferably 0.13 to 0.50 g/cm³. For the determination of the thermal conductivity, an instrument from “C3 Prozess und Analysetechnik”—GmbH of the Hot Disk type with a sensitivity of up to 0.005 W/m*K is preferably used.

For further details on the aerogel according to the invention, reference can be made to the above explanations on the method according to the invention, which apply according to the aerogel according to the invention.

A further subject-matter of the present invention according to a third aspect of the present invention is the use of the aerogel described above for insulation purposes, in particular for sound insulation, electrical insulation or thermal insulation, in particular for thermally insulating purposes.

For further details on the use according to the present invention, reference can be made to the explanations on the further aspects of the invention, which apply according to the present invention with respect to the use according to the present invention.

Again, further subject-matter of the present invention according to a fourth aspect of the present invention is the use of an aerogel as previously described for insulating purposes, in particular as or in thermally insulating materials.

In this context, it may be envisaged that the aerogel is used in loose filling, in a powder mixture or in an insulating composition, for example an insulating plaster.

For further details on the use according to the invention, reference can be made to the above explanations on the further aspects of the invention, which apply according to the use according to the invention.

Yet another subject-matter of the present invention—according to a fifth aspect of the present invention—is an apparatus for producing aerogels, wherein the apparatus comprises
(a) at least one reactor,
(b) at least one inlet opening arranged on the reactor, in particular a nozzle, for supplying fluids, in particular liquids, to the reactor,
(c) at least two feeds connected to the inlet opening, in particular via a mixing device, and
(d) at least one outlet opening arranged on the reactor, in particular a sluice, for the removal of liquids or solids from the reactor.

Within the scope of the present invention, it can in particular be provided that via the at least two feeds connected to the inlet opening, in particular via a mixing device, for example in the form of a mixing section, at least two precursor sols, preferably two precursor sols, for producing a lyogel are first, in particular separately from each other, metered and then mixed with each other in the mixing device, and immediately thereafter the, in particular mixed, precursor sols are supplied, in particular sprayed or dropped, into the reactor.

Preferentially, the reactor comprises not only one but several inlet openings for supplying fluids, in particular liquids, namely at least one nozzle for supplying the, in particular mixed, precursor sols to the reactor and at least one nozzle for supplying further solvents, in particular in liquid and/or gaseous form.

The outlet opening of the reactor is preferentially configured in the form of a sluice in order to be able to quickly remove the lyogel or aerogel from the reactor or also to ensure a multiple solvent exchange by covering and then draining the contaminated solvent from the reactor.

Preferentially, it is also provided that the reactor can be pressurized, in particular with pressures in a range from 1 to 40 bar, preferably 1 to 30 bar, more preferably 1 to 20 bar.

According to a preferred embodiment of the present invention, it is provided that the apparatus comprises at least one inlet and/or outlet opening arranged on the reactor for supplying and/or removing gases to and/or from the reactor.

Preferentially, the pressure in the reactor is regulated by the amounts of substances, in particular in the gas phase and/or a supercritical phase and/or the temperature. For example, pressure regulation may be performed such that gas is supplied to or removed from the reactor.

Furthermore, in the context of the present invention, it is usually provided that the apparatus comprises a device for temperature regulation. Temperature regulation can also be used to specifically influence and control the processes in the reactor and thus in the apparatus as a whole. In particular, it is possible for the reactor to be heated or cooled.

Furthermore, it is preferentially provided that the apparatus comprises at least one device, in particular at least two devices, for measuring the pH value. The device for measuring the pH value can be arranged on the feed lines, the mixing device and/or the reactor. It has been well proven in particular if the device for measuring the pH value is arranged on the feed and/or the mixing device. Furthermore, it has proved advantageous in particular if the device for pH value measurement is arranged in such a way that the pH values of the precursor sols are measured individually and/or after mixing of the precursor sols, in particular continuously, preferably wherein the metering of the precursor sols is carried out as a function of the measured pH values and/or in alignment with a predetermined target pH value, preferably for the precursor sols mixed with each other.

In this context, it is further preferentially provided that the apparatus comprises at least one, in particular two, devices for metering the precursor sols. Preferably, the devices for metering the precursor sols are pumps. It has proved well in particular if the devices for metering the precursor sols can be regulated as a function of the pH value of the precursor sols, in particular mixed with each other.

Usually, the apparatus has a control or regulating device for this purpose, in particular for controlling or regulating the pressure, the pH value and/or the temperature in the reactor and/or the inlet openings or the mixing section.

The apparatus according to the invention can either comprise one reactor or, however, can also comprise several reactors, in particular successive reactors and/or reactors connected with each other, so that the individual method steps of the method according to the invention are each carried out in separate reactors. In this way, continuous aerogel production can be carried out.

For further details on the apparatus according to the invention, reference can be made to the above explanations on the further aspects of the invention, which apply accordingly with respect to the apparatus according to the invention.

Finally, a further subject-matter of the present invention—according to a sixth aspect of the present invention—is a method for producing a lyogel using a sol-gel process, wherein for producing the lyogel at least two precursor sols, preferably two precursor sols, are mixed with each other, wherein a first precursor sol comprises an acidic pH or a basic pH and a second precursor sol comprises a pH value different from the first precursor sol.

With respect to producing the lyogel, all advantages, features and embodiments previously mentioned in the method for producing an aerogel with respect to the lyogel apply accordingly.

For further details on the method for producing a lyogel according to the present invention, reference can be made to the above explanations on the further aspects of the invention, which apply accordingly with respect to the method for producing a lyogel according to the present invention.

The subject-matter of the present invention will be illustrated below in a non-limiting manner and by way of example with reference to the single FIGURE representation and the embodiments in an exemplary and non-limiting manner.

The FIGURE shows a cross-section of an apparatus 1 for carrying out the method according to the invention. The apparatus 1 comprises a reactor 2 in which the lyogel or aerogel formation takes place.

To carry out the method according to the invention, two precursor sols 3 and 4 are preferably mixed with each other, wherein the first precursor sol comprises an acidic pH or a basic pH and the second precursor sol comprises a pH value different from the first precursor sol. In particular, it is preferred in this context if one of the two precursor sols 3 and 4, in particular the first precursor sol 3, comprises an acidic pH and the other precursor sol, in particular the second precursor sol, comprises a basic pH. Accordingly, it is further provided in particular that the precursor sols 3 and 4 are provided separately from each other. The precursors preferably used according to the invention are in particular an, preferably at least partial, aqueous solution of a silicic acid, a silicic sol or a silane hydrolysate.

In a preferred embodiment of the present invention, the acid-adjusted precursor sol 3 comprises a pH value in a range from pH 0 to 6, in particular pH 1 to 4, preferably pH 1.5 to 2.5, while the basic-adjusted precursor sol 4 comprises a pH value in a range from pH 7 to 13, in particular pH 8 to 12, preferably pH 9 to 11.

The precursor sols 3 and 4 are continuously mixed with each other via a feed system, in particular two feeds 5. Here, the feeds 5 can be regulated or opened via valves 6. Furthermore, by means of a metering device 7, in particular by means of pumps, the feed or the amount of precursor sols 3 and 4 mixed with each other for lyogel production or formation can be controlled or metered in particular.

In a further preferred embodiment of the present invention, the metering of the precursor feed is carried out as a function of the pH value of the, in particular mixed, precursor sols 3 and 4. In this respect, it has been well proven in accordance with the invention if the mixed precursor sols 3 and 4 comprise a pH value in a range from pH 4.5 to 9.5, in particular pH 5 to pH 9, preferably pH 5.3 to 8.5. Particularly good results, in particular a particularly precise control as well as tuning of the lyogel formation, can be achieved within the scope of the present invention if the mixed precursor sols 3 & 4 comprise a weakly acidic pH, in particular in a range from pH 4.5 to 6.8, preferably pH 5 to 6.5, or a weakly basic pH, in particular in a range from pH 7.5 to 9.5, preferably pH 7.8 to 9. In this respect, it is even more preferred for the method according to the invention, in particular with regard to the aerogel properties formed in the finally obtained aerogel, if the mixed precursor sols 3 and 4 comprise a weakly acidic pH value in the aforementioned range.

According to the invention, the apparatus 1 preferably comprises a mixing device 8. In the FIGURE representation, the mixing device is represented exemplarily in the form of a mixing section, which in particular contains static mixing elements 9. The mixing device preferably merges into or comprises an inlet opening, for example in particular in the form of a nozzle. In this context, it is possible that the mixing device is a nozzle, i.e. that the precursor sols 3 and 4 are mixed in the nozzle immediately before being supplied into the reactor 2. However, it is preferred if the mixed precursor sols 3 and 4 remain in the mixing device 8 for a certain time so that complete mixing of the precursor sols 3 and 4 is ensured and, if necessary, a desired pre-gelation sets in. The specific mixing parameters of the mixing device 8 depend in particular on the geometry of the mixing device 8, the chemical and physical properties of the precursor sols 3 and 4, and the shape and properties of the aerogel particles to be produced.

Preferably, the feeds 5 can also be connected to the mixing device 8 via a T-piece. Mixing of the precursor sols 3 and 4, which are provided separately and metered separately from each other, in particular continuously, is carried out in the mixing device 8, wherein preferentially homogeneous and uniform mixing can be achieved using the integrated mixing elements 9. Immediately after mixing of the precursor sols 3 and 4, gel formation and, preferably dropwise, supply, preferably injection, of the precursor sols 3 and 4 via an inlet opening 10, in particular a nozzle, into the reactor 2 are carried out simultaneously. Here, starting from the geometry of the inlet opening 10, in particular the nozzle, it is also possible, in particular, to control the shape or geometry of the formed lyogel particles.

With coordination of the respective quantities of precursor sols 3 and 4 metered into the mixing device 8 as a function of the in particular predefined pH value for the mixed precursor solutions, lyogel formation is initiated with passage through the mixing device 8 as well as the static mixing elements 9, preferably within a time span of less than 60 seconds, in particular less than 30 seconds, preferably less than 20 seconds, as well as more than 0.1 seconds, in particular more than 0.5 seconds, preferably more than 1 second. In this context, it is in particular decisive that, on the basis of the targeted pH value adjustment as well as the uniform and controlled homogeneous mixing of the precursor solutions 3 and 4 in the mixing device 8, in particular spherical, lyogel particles 11 with a uniform size distribution as well as also specifically adjustable size can be obtained reliable and process-safe.

In the context of the present invention, it is further preferably provided here that producing the lyogel 11 is carried out at a pressure of less than 40 bar, in particular less than 30 bar, preferably less than 20 bar, more preferably at atmospheric pressure, i.e. about 1 bar, and at temperatures above 50° C., in particular 60° C., preferably 70° C., more preferably 80° C. In addition, it has proven advantageous if a controlled gas atmosphere, in particular a CO₂, N₂ or Ar atmosphere or an atmosphere consisting of a mixture of these gases, is provided in reactor 2.

The formed lyogel particles 11 collect at the bottom of the reactor 2, wherein, however, the in particular spherical shape is obtained in particular unimpaired. The lyogel particles 11 can now either be removed from the reactor 2 or can be further processed in the reactor. Preferentially, after producing the lyogel 11, a solvent exchange is performed with simultaneous hydrophobing of the lyogel 11 using a suitable organic solvent as well as a hydrophobing agent, in particular a silanizing agent.

Solvent and hydrophobing agent are supplied to the reactor 2 via the inlet openings 12 and 13, respectively. Here, it is preferred if the organic solvent is soluble in CO2 to enable enclosing supercritical drying with CO2. Gases, such as CO2, can therefore in particular also be supplied to the reactor via the inlet openings 12 or 13 and, if necessary, removed again. After solvent exchange has taken place, the lyogel 11 is dried, in particular by first draining the solvent through the outlet opening 14 and then carrying out supercritical drying of the lyogel using CO2, so that an aerogel is obtained.

Finally, with regard to the control or regulation of the apparatus 1 according to the present invention for carrying out the method according to the present invention, it is preferred if the apparatus 1 comprises measuring devices 15, in particular wherein these are preferably suitable for measuring pressure, temperature and/or pH.

The subject-matter of the present invention is explained below by means of working examples in a non-limiting manner:

### WORKING EXAMPLES

Silica aerogels are produced from silicic acids as precursors using the method according to the invention and the properties of the obtained aerogel particles are investigated:

1. Producing the Aerogels

Producing the Acidic Precursor Sols:

For producing the acid adjusted precursor sols, silicic acid is prepared from sodium silicate using ion exchange against protons. The solids content is adjusted to 5 to 10 wt. %, preferably 7 to 8 wt. %.

The silicic acid thus produced comprises a pH of 1.8 to 2.4 to preferably 2.0. For storage of the silicic acid, it can be stabilized to a pH of 1 to 1.5 using HCl.

Producing the Basic Precursor Sols:

For producing the basic precursor sols, silicic acid is again first produced from sodium silicate using ion exchange. The solids content is adjusted to 5 to 10 wt. %, preferably 7 to 8 wt. %.

The pH of the silicic acid is adjusted to a pH of 9 to 11, preferably 10.5, a few minutes before use by using NH3 (approx. 25%, approx. 4.5 g/100 g solution). Very rapid addition and very rapid mixing of the aqueous NH3 solution are essential to prevent immediate gelation.

The ammonia addition is 7.0 ml ammonia 25 wt. % per 100 g silicic acid solution. The storage time of such a solution is usually only a few hours, preferentially a maximum of 2 hours.

Alternatively, commercial silica sols can be used as a basic solution. For example, Ludox SM with a solids content of 30 wt. % and a pH of about 10, or LUDOX AS-40, which comprises a lower sodium content, or mixtures of these are suitable.

Mixing Ratios of Precursor Sols for Lyogel Formation:

The following table lists the mixing ratios in which the above precursor sols are used in the method of the invention for producing the lyogel.

TABLE 1
Mass balances of the silicic acid solutions
to be mixed and the corresponding pH values

| Proportion | Proportion | | | |
|---|---|---|---|---|
| basic solution | acidic solution | B/S | NH₃ | obtained |
| in [g] | in [g] | ratio | wt.-% | pH-value |
| Silicic | Silicic | | | |
| acid solution | acid solution | | | |
| 7 wt. %, pH 11 | 7 wt. %, ca. pH 2 | | | |
| 3.50 | 50.0 | 0.070 | 0.39 | 5.75 |
| 3.75 | 50.0 | 0.075 | 0.41 | 6.11 |
| 4.00 | 50.0 | 0.080 | 0.45 | 6.55 |
| Silica sol | Silicic | | | |
| LUDOX SM | acid solution | | | |
| 7 wt. %, pH 10.5 | 7 wt. %, ca. pH 2 | | | |
| 10.0 | 50.0 | 0.20 | | 6.15 |
| Silica sol | Silicic | | | |
| LUDOX SM | acis solution | | | |
| 10 wt. %, pH 9.1 | 7 wt. %, pH 2 | | | |
| 25.0 | 50.0 | 0.50 | | 6.45 |

Procedure for the Formation of Lyogels and Aerogels

The silicic acid solutions prepared as described above are mixed in an apparatus according to the invention, preferentially via a two-substance feed using a T-piece and subsequently a static mixer in the form of a tube insert and using two pumps. In particular, models for low-viscosity systems are suitable as static mixers, e.g. with a diameter-length ratio of 1:5, for example according to the “Kenics” design. Preferentially, gelation occurs immediately upon mixing of the two solutions, so that the mixed precursor solutions can be dripped with short gelation times at resulting pH values close to the neutral range. The formed lyogel particles, in particular hydrogel particles, collect at the bottom of the apparatus, preferentially in the form of spherical particles.

Since the water present in the lyogels or in particular hydrogels would interfere with the drying process for conversion into an aerogel, it is preferentially exchanged for a suitable, in particular CO₂-soluble, solvent, e.g. ethanol. For this purpose, the solvent exchange preferably takes place at a pressure of about 1 to 30 bar and temperatures between 30° C. and 150° C. The gel stored in the reaction apparatus according to the invention, in particular the autoclave, is covered with the solvent, for example ethanol, in liquid form. For this purpose, the autoclave is pressurized in particular to prevent boiling of the solvent, wherein for ethanol the vapor pressure of 5.6 bar is at 130° C., so that a pressurization of 10 bar is suitable here.

Furthermore, hydrophobing of the lyogel can also be performed as part of the solvent exchange. For this purpose, the gels are overlaid with a liquid mixture of ethanol and hexamethyldisilazane (HDMZ), wherein the simultaneous addition of HDMZ leads to hydrophobing of the gels. Alternatively, exclusive contact of the gels with a gas phase saturated with ethanol can also lead to sufficient solvent exchange.

After a residence time of 30 min, the liquid ethanol is drained from the container. Further washing cycles can then follow by adding ethanol to the container, wherein the objective is to bring the water content of the gels below 10% by volume. In this case, the ethanol phase is replaced after every 20 min. It has proved particularly advantageous if the first solvent exchange is carried out in such a way that the gels are covered with the liquid ethanol phase.

After the end of the solvent exchange, in particular if the gels contain less than 5 wt. % water, the gel particles can be supercritically dried. For this purpose, compressed carbon dioxide is fed in as a drying fluid, wherein the gas flow can be used for targeted continuous drying of the organogels and single-stage aerogel particle generation can be ensured. Based on the spherical particle shape and a typical particle diameter between 1 and 6 mm, supercritical drying can be carried out in a time window of 10 to 60 min at a pressure in a range of 120 to 160 bar and a temperature in a range of 60 to 120° C.

2. Characterization of the Aerogels

The characterization of the aerogels obtained according to the invention is carried out as described below:

Particle Sizes:

The sieve analysis method is used to determine the size of the obtained aerogel particles according to the invention. Smaller particles in the size range below 1 mm are additionally measured by light microscopy.

The particle size analysis has shown that aerogel particles according to the invention comprise particle sizes in the range of 0.1 to 10 mm, in particular 0.2 to 8 mm, preferably 0.3 to 7 mm.

Thermal Conductivity:

To determine the thermal conductivity, an instrument from C3 Prozess und Analyse-technik GmbH of the Hot Disk type with a sensitivity of up to 0.005 W/m*K is used. The Hot Disk sensor here consists of a nickel double spiral, which serves both as a heat source and for measuring the temperature rise during the measurement.

For aerogels according to the invention, thermal conductivities in the range of 0.012 to 0.025 W/mK, in particular 0.013 to 0.022 W/mK, preferably 0.014 to 0.020 W/mK, are measured.

Pore Volume and Density:

To determine the density and pore volume, studies were carried out using mercury porosimetry. Here, the sample is subjected to up to 400 MPa pressure, which destroys the sample, but thereby also allows complete detection of the internal pore volume.

Commercially obtained, subcritically dried and hydrophobized aerogel Enova P300 (Cabot Corporation, average density according to data sheet approx. 150 kg/m³) and aerogel Enova 3110 (Cabot Corporation) serve as reference.

The density of aerogel particles according to the invention is in a range of 0.01 to 0.60 g/cm³, in particular 0.11 to 0.55 g/cm³, preferably 0.12 to 0.50 g/cm³, according to the results of mercury porosimetry,

Porosity, BET Surface Area and Mean Pore Radius:

To determine the porosity, BET surface area and mean pore radius of the aerogels according to the invention, the nitrogen adsorption of the aerogels was measured and/or determined using the BET method. For this purpose, the measurement is generally carried out according to DIN ISO 9277:2003-05 (“Determination of the specific surface area of solids by gas adsorption using the BET method”).

According to the aforementioned method, values for porosity of 94 to 99.5%, in particular 95 to 99%, preferably 96 to 98%, are obtained for aerogels according to the invention. Furthermore, the aerogels comprise a BET surface area in the range of 500 to 1,000 m²/g, in particular 600 to 1,050 m²/g, preferably 650 to 1,000 m²/g.

### REFERENCE SIGNS

| | |
|---|---|
| 1 | apparatus |
| 2 | reactor |
| 3 | precursor sol |
| 4 | precursor sol |
| 5 | feed |
| 6 | valve |
| 7 | metering device |
| 8 | mixing device |
| 9 | static mixing elements |
| 10 | inlet opening |
| 11 | lyogel particles |
| 12 | inlet opening |
| 13 | inlet opening |
| 14 | outlet opening |
| 15 | measuring device |

1. A method for producing a silica aerogel using a sol-gel process, in which first a lyogel is formed and the lyogel is then converted into an aerogel,
wherein
for producing the lyogel at least two precursor sols, preferably two precursor sols, are mixed with each other, wherein a first precursor sol comprises an acidic pH value or a basic pH value and a second precursor sol comprises a pH value different from the first precursor sol.

2. The method according to claim 1, wherein the precursor sols are mixed with one another and are supplied, in particular immediately after mixing, into a reaction apparatus, preferably in the form of droplets, more preferably dropwise.

3. The method according to claim 1, wherein the precursor sols for producing the lyogel are continuously mixed with each other, in particular by means of a feed system, preferably by means of a two-substance feed.

4. The method according to one claim 1, wherein the precursor sols are provided separately from each other.

5. The method according to claim 1, wherein the first precursor sol comprises an acidic pH and the second precursor sol comprises a basic pH.

6. The method according to claim 1, wherein the acidic pH is in a range of pH 0 to 6, in particular pH 1 to 4, preferably pH 1.5 to 2.5.

7. The method according to claim 1, wherein the basic pH is in a range of pH 7 to 13, in particular pH 8 to 12, preferentially pH 9 to 11.

8. The method according to claim 1, wherein the precursor sols mixed with each other comprise a pH value in a range from pH 4.5 to 9.5, in particular pH 5 to pH 9, preferably pH 5.3 to 8.5.

9. The method according to claim 8, wherein the precursor sols mixed with each other comprise a weakly acidic pH, in particular in a range from pH 4.5 to 6.8, preferably pH 5 to 6.5, or a weakly basic pH, in particular in a range from pH 7.5 to 9.5, preferably pH 7.8 to 9.

10. The method according to claim 1, wherein the production of the lyogel is carried out at a pressure of less than 40 bar, in particular less than 30 bar, preferably less than 20 bar, more preferably less than 10 bar, particularly preferred at atmospheric pressure.

11. The method according to claim 1, wherein the production of the lyogel from the mixed precursor sols takes place within less than 60 seconds, in particular less than 30 seconds, preferably less than 20 seconds, more preferably less than 10 seconds, further preferably less than 5 seconds.

12. The method according to claim 1, wherein the precursor sols comprise silicon-based precursors.

13. The method according to claim 12, wherein the precursor sols contain silicon in amounts in a range from 3 to 20 wt. %, in particular 4 to 15 wt. %, preferably 5 to 10 wt. %, based on precursor sols.

14. The method according to claim 12, wherein the precursors are selected from the group of silicas, in particular colloidal silicic acid, silica sols, silicic acid sols, silanes, in particular tetraalkoxysilanes, siloxanes, silicates and mixtures thereof.

15. A silica aerogel, in particular obtainable according to claim 1, wherein the silica aerogel is in the form of particles with an in particular at least substantially circular cross-section and in that the silica aerogel comprises particle sizes in the range of 0.1 to 10 mm.

16. The silica aerogel according to claim 15, wherein the silica aerogel comprises particle sizes in the range of 0.2 to 8 mm, preferably 0.3 to 7 mm, more preferably 0.5 to 5 mm.

17. The use of a silica aerogel according to claim 15 for insulation purposes, in particular for sound insulation, electrical insulation or thermal insulation, in particular for thermally insulating purposes, or as a carrier material, as an absorbent or as an adsorbent.

18. The use of a silica aerogel according to claim 15 for insulation purposes, in particular as or in thermally insulating materials.

19. An apparatus for producing aerogel and/or obtainable by a method according to claim 1, wherein
the apparatus comprises
(a) at least one reactor,
(b) at least one inlet opening arranged on the reactor, in particular a nozzle, for supplying fluids, in particular liquids, to the reactor,
(c) at least two feeds connected to the inlet opening via a mixing device, and
(d) at least one outlet opening arranged on the reactor, in particular a sluice, for the removal of liquids or solids from the reactor.

20. A method for producing a silica-lyogel using a sol-gel process,
wherein
for producing the lyogel at least two precursor sols, preferably two precursor sols, are mixed with each other, wherein a first precursor sol comprises an acidic pH or a basic pH and a second precursor sol comprises a pH value different from the first precursor sol.
